(19) United States
(12) Patent Application Publication
(10) Pub. No.: US 2010/0153707 A1
(43) Pub. Date: Jun. 17, 2010

(54) Systems and Methods for Real-Time Verification of A Personal Identification Number

(76) Inventor: John H. Lentz, II, Foothill Ranch, CA (US)

Correspondence Address: PATENTMETRIX, 14252 CULVER DR. BOX 914, IRVINE, CA, 92604, US

(21) Appl. No.: 12/611,923

(22) Filed: Nov. 3, 2009

Related U.S. Application Data
(60) Provisional application No. 61/111,072, filed on Nov. 4, 2008.

(51) Int. Cl. H04L 29/06; H04L 9/32; G06F 17/30; H04L 9/00; G06F 17/00

(52) U.S. Cl. 713/155; 726/5; 715/222

(57) ABSTRACT

The present invention is directed to improved methods and systems for verifying a person's personal identification data. In one embodiment, the system includes programmatic modules stored on computer readable media. The programmatic modules receive login credentials from a computing device and verify credentials, generate and communicate a request form for accessing personal identification data associated with a person, receive input data from a computing device in response to a request form, test input data in relation to a minimum required data set for requesting personal identification data, format input data into an electronic request in accordance with a predefined format, store, search, and identify a consent form, which establishes a valid consent by a person to access personal identification data, associate the electronic request for a person's personal identification data with a consent form, and transmit the electronic request in accordance with a predefined format to another computing device.

### CROSS-REFERENCE

The present application relies on U.S. Provisional Application No. 61/111,072, filed on Nov. 4, 2008 for priority.

### FIELD OF THE INVENTION

The present invention generally relates to the field of personal identification number verification, including Social Security Number (SSN) verification, and more specifically to a system and method to verify an individual's social security number on a real-time or instantaneous basis.

### BACKGROUND OF THE INVENTION

Identity theft and fraud is a serious issue that negatively impacts a vast number of business transactions—both online and offline, ultimately leading to huge financial and opportunity losses to organizations and individuals alike. Identity fraud also leads to security threats and jeopardize the very fabric of modern society.

Generally, companies use third party services for verification of information and identity. Verification requests can be quite complicated and have several layers of complexity, including formatting the request, obtaining the proper consent from the individual whose identity or information is being verified, managing the response to the request, and managing delivery of the response to the request. In addition, it is preferred to have the verification performed by a disinterested third party to mitigate the possibility of fraud.

In the United States, the Social Security Number (SSN) is a unique 9-digit number that is used to identify an individual and has a plurality of important information linked to it about the individual. Such information comprises name, gender, address, etc. that may be utilized to help accurately identify the individual. To address misrepresentation of personal identity, the Social Security Administration (SSA), for example, provides a SSN verification service where SSN verification requests can be submitted to a) determine if the SSN exists and b) ascertain if the person who provided the SSN correlates with that SSN.

In addition, the current SSN verification service offered by SSA has a rather long turnaround time. For example, to verify whether a person with name X is actually verified as having SSN Y, it may take as long as two business days. Additionally, one of the key requirements of the SSN verification service is the presence of a valid consent form from the individual whose SSN is being verified.

Even if an agency such as SSA offers a SSN verification service with instantaneous and quick turnaround, prior art systems that utilize SSNs for identity verification and/or authentication of individuals for various purposes do not effectively address the complexities arising from complying with agency request requirements, specifically, a) formatting verification requests, managing verification requests, and delivering verification requests in real-time or instantaneously between the user and the agency and b) managing an individuals' consent (by way of a signed form).

For example, PCT Application WO-A 2001031483 assigned to Stock Power Inc., describes “[a]n on-line commerce system and method for using a multi-layered identification scheme to identify users. The system accurately links anonymous Internet users to a real world address by using a multi-layered authentication component. The authentication component includes a normalization component, a reflexive check component, an internal check component, a cross-reference check component and a physical location check component” that “uses the investor's social security number and an external database to verify and cross check the investor's name and address. The application is rejected if the name and address verification fails. In Step 8060, cross-reference check component 308 then searches the investor's data in the database and evaluates any additional information on the investor, and then searches the additional information for predetermined codes indicating potentially fraudulent behavior. For example, predetermined codes may indicate a suspicious address or information, such as a social security number entered by the investor that belongs to a deceased person. Cross-reference check component 308 rejects the application if there are certain suspicious information codes associated with the investor. Rules engine 300 then constructs a bit vector showing the scoring results for each test. Certain bit patterns will cause the application to be rejected. If the application is not rejected, the investor's account is marked as pending and a request to credit the investor's is credit card for the application-processing fee is created. The investor may now enter transactions. However, they will not be processed until the account status is chanced to approved.”

U.S. Pat. No. 6,263,447, assigned to French et al, describes “[a] network authentication system provides verification of the identity or other attributes of a network user to conduct a transaction, access data or avail themselves of other resources. The user is presented with a hierarchy of queries based on wallet-type (basic identification) and non-wallet type (more private) information designed to ensure the identity of the user and prevent fraud, false negatives and other undesirable results. A preprocessing stage may be employed to ensure correct formatting of the input information and clean up routine mistakes (such as missing digits, typos, etc.) that might otherwise halt the transaction. Queries can be presented in interactive, batch processed, or other format. The authenticator can be configured to require differing levels of input or award differing levels of authentication according to security criteria.” Herein “In a preferred embodiment, the preprocessing step 26 may perform one or more of the following validation checks . . . 2) Social Security Check. The input social security number is compared with one or more published social security number tables or processed using one or more algorithms to determine its validity. These tables may include such information as numbers reported as deceased or fraudulent.”

Further, U.S. Pat. No. 6,164,528 to Hills et al describes “[a] point of sale system” where “[t]he present invention has the additional capability to use a consumer's Social Security Number to perform a variety of identification and fraud preventative applications prior to issuing an “Approved” message for the Transaction Event. These include searches employing Social Security Number first to validate the consumer's Social Security Number as a genuinely issued number. Second, the system cross searches the system's “Dead File” to screen out Social Security Numbers which, while validly issued, were issued to individuals now reported as deceased. To a greater extent, verification and “Dead File” searches deter access by consumers attempting to use false identification. Lastly, the present system utilizes Social Security Numbers to cross search all “Known” checkwriter banking account records for negative information before issuing an “Approved” message for the subject Transaction Event. This capability more fully insulates the system and its system subscribers from abuse and susceptibility to repeat abusers who would commonly seek to process Transaction Events from a multiplicity of banking accounts.”

Still further, U.S. Pat. No. 7,275,110 to Umbreit describes “[a] system and method for an access code issuer to receive an on-line application including certain personal information from a user of a computer network such as the Internet, to independently operatively connect to a database and obtain or verify demographic and additional personal information regarding the user, and issue an access code to the user. The user enters this access code when accessing various nodes or websites of a plurality of affiliated content providers. The content providers obtain or verify the user's demographics by operatively connecting to the access code issuer, thereby obtaining or verifying the demographics of the visitor to its site without requiring the visitor to enter his or her demographic information or to independently provide proof thereof to the content provider. The content provider can then customize the presentation and advertising on its site according to the demographics of the user, and/or can restrict access to its site or portions thereof based on demographics or other information regarding the user. Authentication is provided using a portion of a social security number.”

Thus, there is a need for a personal identification number, e.g. SSN, checking/verification system where SSN verification is accomplished on a real-time basis or instantaneously.

What is also needed are novel methods and systems to manage consent of individuals for their SSN verifications, such that the real-time nature of the SSN checking/verification system is maintained.

### SUMMARY OF THE INVENTION

The present invention is directed to an improved method and system for verifying a person's personal identification data. In one embodiment, the present invention is a plurality of programmatic modules stored on computer readable media and, when installed on a computer device, execute on at least one processor comprising: a) a first programmatic module for receiving login credentials from a first computing device across a network and for verifying said credentials, b) a second programmatic module for generating, and communicating to said first computing device, a request form for accessing personal identification data associated with a person, c) a third programmatic module for receiving input data from said first computing device across a network in response to said request form, d) a fourth programmatic module for testing said input data in relation to a minimum required data set for requesting said personal identification data, e) fifth programmatic module for formatting said input data into an electronic request in accordance with a predefined format, f) A sixth programmatic module for storing, searching, and identifying a consent form, wherein said consent form establishes a valid consent by said person to access said personal identification data, g) a seventh programmatic module for associating said electronic request for said person's personal identification data with said consent form, and h) an eighth programmatic module for transmitting said electronic request in accordance with a predefined format to a second computing device.

Optionally, if said sixth programmatic module cannot identify said consent form executed by said person, said sixth programmatic module causes a signal to be communicated to said first computing device and wherein said signal causes said first computing device to display a request for said consent form executed by said person. If said sixth programmatic module cannot identify said consent form executed by said person, said eighth programmatic module does not submit said electronic request in accordance with a predefined format to a server. Optionally, if said sixth programmatic module can identify said consent form executed by said person, said eighth programmatic module submits said electronic request in accordance with a predefined format to a server. Optionally, the personal identification data is a social security number.

Optionally, said first programmatic module is configured to establish an encrypted connection with said first computing device. Optionally, said sixth programmatic module is configured to access a database and wherein said database stores executed consent forms in an electronic format. Optionally, said sixth programmatic module is configured to access a database and said database stores metadata of stored consent forms, said metadata comprising data extracted from said stored consent forms and placed into an electronically searchable format. Optionally, the programmatic modules further comprise a ninth programmatic module for accessing results of at least one previously submitted electronic request. Optionally, the programmatic modules further comprise a tenth programmatic module for receiving results of at least one electronic request from a third computing device.

In another embodiment, the present invention is a system for obtaining social security information of a person with consent from said person comprising: a) a processor; b) a memory for storing a plurality of programmatic modules, wherein each of said programmatic modules execute on said processor and wherein said plurality of programmatic modules comprise: (i) a first programmatic module for receiving login credentials from a first computing device across a network and for verifying said credentials; (ii) a second programmatic module for generating, and communicating to said first computing device, a request form for accessing said social security information associated with said person; (iii) a third programmatic module for receiving input data from said first computing device across a network in response to said request form; (iv) a fourth programmatic module for testing said input data in relation to a minimum required data set for requesting said social security information; (v) a fifth programmatic module for formatting said input data into an electronic request in accordance with a predefined format; (vi) a sixth programmatic module for storing, searching, and identifying a consent form, wherein said consent form establishes a valid consent by said person to access said social security information; (vii) a seventh programmatic module for associating said electronic request for said person's social security information with said consent form; and (viii) an eighth programmatic module for transmitting said electronic request in accordance with a predefined format to a second computing device; and c) a database, wherein said database stores executed consent forms in an electronic format and wherein said database is accessible by at least one of said plurality of programmatic modules.

Optionally, if said sixth programmatic module cannot identify said consent form executed by said person, said sixth programmatic module causes a signal to be communicated to said first computing device and said signal causes said first computing device to display a request for said consent form executed by said person. If said sixth programmatic module cannot identify said consent form executed by said person, said eighth programmatic module does not submit said electronic request in accordance with a predefined format to a server. If said sixth programmatic module can identify said consent form executed by said person, said eighth programmatic module submits said electronic request in accordance with a predefined format to a server. The first programmatic module is configured to establish an encrypted connection with said first computing device. The database stores metadata of stored consent forms, said metadata comprising data extracted from said stored consent forms and placed into an electronically searchable format. The system further comprises a ninth programmatic module for accessing results of at least one previously submitted electronic request. The system further comprises a tenth programmatic module for receiving results of at least one electronic request from a third computing device. The system further comprises an eleventh programmatic module for establishing an encrypted connection with said third computing device.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 is a diagram illustrating one embodiment of the SSN verification system of the present invention, for real-time or instantaneous verification of SSN;

FIG. 2 is a flow chart describing operational steps of the SSN verification system of the present invention, for real-time or instantaneous verification of SSN;

FIG. 3 shows an embodiment of a standard consent form for obtaining individual consent for SSN verification;

FIG. 4 is a flowchart describing operational steps of one exemplary application of the system and method of the present invention, where an individual wishes to initiate a “credit report scrub” from a credit reporting agency;

FIG. 5 is a flowchart describing operational steps of another exemplary application of the system and method of the present invention, where an individual is in the process of applying for a credit card from a financial institution;

FIG. 6 is a flowchart describing operational steps of yet another exemplary application, where an individual applies for property rental, such as an office space or residential apartment;

FIG. 7 is a flowchart describing operational steps of another exemplary application, where an individual seeks electricity connection from an electricity distribution agency;

FIG. 8 is a flowchart describing operational steps of an exemplary application, where an individual enters into an online purchase or e-commerce transaction;

FIG. 9 is a flowchart describing operational steps of another exemplary application, where SSN check is performed before approving a garnishment of wages;

FIG. 10 is a flowchart describing operational steps of another exemplary application, where a human resources department requests a real-time SSN check of at least one employee either prior to or during employment;

FIG. 11 is a flowchart describing operational steps of an exemplary application, where a physician, or other professional, initiates a real-time SSN verification prior to accepting a new patient or client;

FIG. 12 is a flowchart describing operational steps of another exemplary application, where insurance companies, offer lower premiums to individuals in exchange for an imposed requirement for real-time SSN verifications on their credit report;

FIG. 13 is a flowchart describing operational steps of yet another exemplary application, where a city clerk or government official conducts a real-time SSN check before issuing a license;

FIG. 14 is a flowchart describing operational steps of another exemplary application, where an individual consents to a SSN verification upon purchase of a ticket for public transportation;

FIG. 15 is a flowchart describing operational steps of another exemplary application, where an attorney ascertains an individual's SSN along with his/her creditworthiness during the process of bankruptcy declaration by the individual; and

FIG. 16 is a flowchart describing operational steps of a yet another exemplary application, where a debt renegotiation site conducts an individual's SSN check as part of a debt renegotiation.

### DETAILED DESCRIPTION OF THE INVENTION

In one embodiment, the present invention is directed towards personal identification number verification systems, e.g. Social Security Number verification systems, and methods whereby personal identification number verification, including SSN verification, is accomplished on an instantaneous or real-time basis. In another embodiment, the present invention is directed towards a Social Security Number verification system and method for managing consent of individuals for instantaneous SSN verification.

It should be noted herein that for purposes of describing the present invention, terms are defined as follows:
a. “System” refers to the personal identification number verification system of the present invention.
b. “Individual” refers to the person whose SSN is to be verified. This person may also be referred to as the “end-user”.
c. “Customer” or “Client” refers to the party requesting verification of the individual, such as banks and other institutions that would need to initiate such a check.
d. “Agency” refers to any entity capable of verifying an individual's identity, including government agencies and, more specifically, the Social Security Administration, Homeland Security, Immigration and Naturalization Services, Department of Motor Vehicles, among others.

In one embodiment, the present invention is directed towards a Social Security Number Verification system that receives a customer or client's log-on or identification, the name of the individual to be verified, and the social security number of the individual to be verified. In another embodiment, the present invention is directed towards managing individual consent for obtaining SSN verification information instantaneously. It should be appreciated that the present application can be directed toward any type of personal identification verification, including driver's license numbers, passport numbers, citizenship data, alien registration numbers, or any other identifying number that is personal to the individual and assigned by a government agency.

In one embodiment, the present invention is directed towards a Social Security Number Verification system that receives a customer's log-on or identification, the name of the individual to be verified, and the social security number of the individual to be verified, and any other relevant information for that application, such as, but not limited to mortgage loan number, credit card application number, and travel ticket number. Once received, in one embodiment, the system of the present invention reviews the request, approves it, optionally aggregates a plurality of SSN verification requests, and converts the request(s) into a usable format for submission to the SSN verification agency (hereinafter referred to as the ‘agency’). Once submitted to the ‘agency’ and processed by the ‘agency’, the system of the present invention then receives the requested data from the ‘agency’, converts it into a format usable by the customer, and then delivers it to them in that specialized format. In one embodiment, delivery is effectuated via encrypted e-mail. In another embodiment, the data is posted to the website for secure access by the customer.

Various modifications to the preferred embodiment, disclosed herein, will be readily apparent to those of ordinary skill in the art and the disclosure set forth herein may be applicable to other embodiments and applications without departing from the spirit and scope of the present invention and the claims hereto appended. Reference will now be made in detail to specific embodiments of the invention. Language used in this specification should not be interpreted as a general disavowal of any one specific embodiment or used to limit the claims beyond the meaning of the terms used therein.

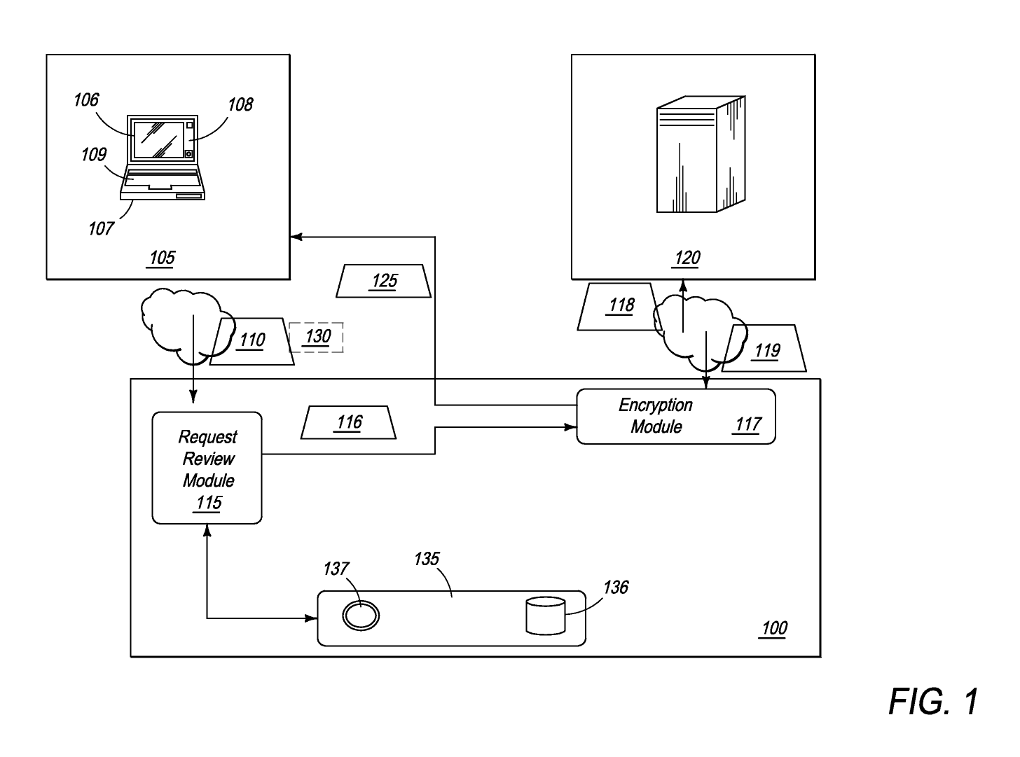

FIG. 1 shows a “Social Security Number” (hereinafter referred to as “SSN”) verification system 100 in accordance with one embodiment of the present invention. System 100 is described with respect to its use in a general verification scenario. It should be noted that this system can be used for any type of personal identification number verification, including social security numbers, driver's license number, passport numbers, or other forms of personal identification, as will be described in greater detail below with respect to specific examples. Thus, the example described herein is not intended to be limiting. In one embodiment, SSN Verification System 100 comprises SSN Verification Request Review Module 115, Encryption Module 117, and Consent Form Management Module 135.

Client 105 is in data communication with system 100, either wired or wirelessly and via a web-enabled application with a front-end graphical user interface (GUI) 106 on a computer system 107 having a display 108 for displaying the GUI 106 and an input device such as a keyboard 109. In addition, system 100 is in data communication with Agency Server 120, via a web application.

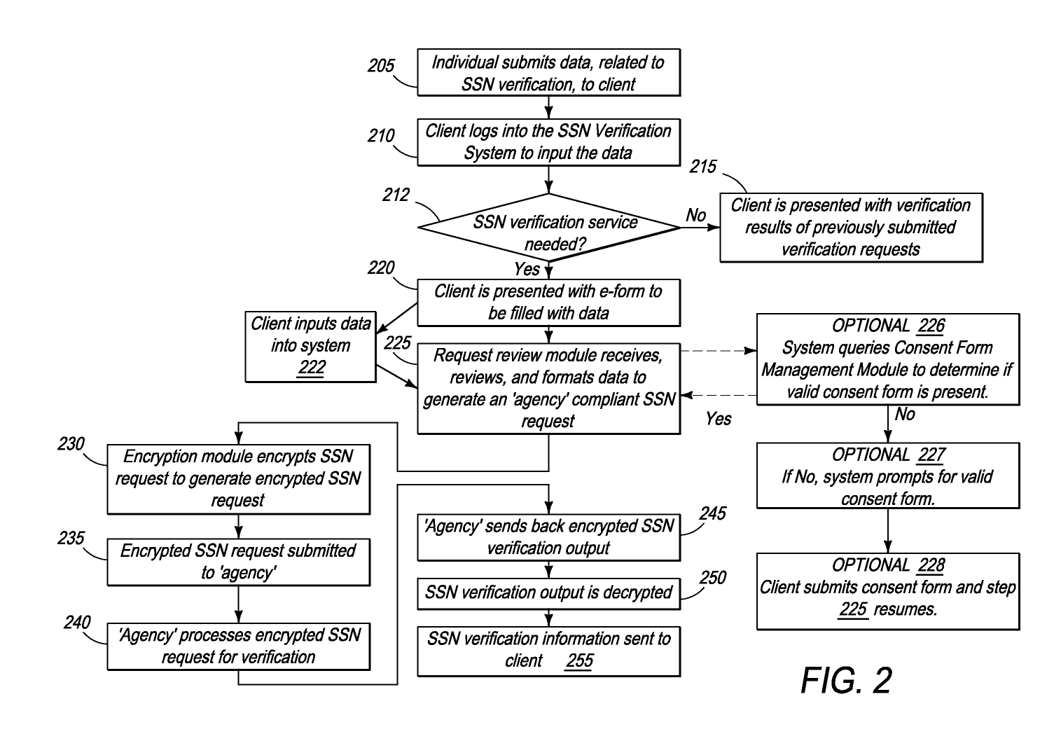

FIG. 2 is a flow chart describing operational steps for using the SSN verification system of the present invention. Reference will also be made to FIG. 1 to refer back to system components that are employed in each step. An individual who wants to do business with client 105 submits to client 105, in step 205, data 110 pertaining to a request to verify/check the authenticity of his SSN. Optionally, the individual also submits consent form 130 to client 105.

In step 210 registered client 105 logs into system 100 via web GUI 106 using his unique login credentials. In one embodiment, client 105 can log-in to system 100 by accessing GUI 106 on the Internet or via a VPN for submission of data 110. A client log-in may be established by registering with system 100 as is customary to those of ordinary skill in the art. In one embodiment, a client 105 may register on a “per-use” or “per-web session” basis.

On login client 105 is presented, at step 212, with service options, including, but not limited to first option 212a to access results of the earlier submitted SSN verification request(s) and second option 212b to access the SSN verification service and submit new requests. On selecting first option 212a, client 105 is presented, at step 215, stored verification results from the ‘agency’ 120, of the previously submitted all or ‘n’ requests.

In one embodiment, upon selecting second option 212b, system 100 (via GUI 106) presents client 105, in step 220, with a web application form (E-form) prompting for relevant data points 110 for generating an ‘agency’ compliant SSN Request 116 for submission to ‘agency’ 120. In one embodiment, the web form presents a row comprising input fields for data 110 such as, but not limited to, the SSN, the first, middle and last names, suffix, date of birth, gender and any other input fields as would be mandated by the ‘agency’. Necessary input field validations are programmed to implement rules such as: ensuring that the necessary/mandatory fields are not left blank and the form and content of all fields are compliant with the requirements of the ‘agency’ (for example checking that the SSN submitted is of 9 digits). Input fields are discussed in greater detail below.

In one embodiment, in step 222, client 105 inputs at least one piece of the data 110 into system 100 via the web application form presented on the GUI 106. Data 110 may be derived from physical documents and/or in electronic form. For example, the individual or end-user may provide data 110 to the client 105 through means such as telephone, fax, SMS messaging, email or any other means that would be evident to persons of ordinary skill in the art. In case of a telephone call, the individual verbally communicates data 110 that is recorded or documented. Therefore, in one embodiment, client 105 extracts information from physical and/or electronic documentation for input into system 100.

The ‘agency’ provides a consent based SSN verification service for verifying or validating SSN information. However, to use the service, the SSN request—in one embodiment—needs to a) contain specific data points and b) be submitted to the ‘agency’ in a specified format. Thus, in one embodiment, the at least one piece of data 110 is processed and formatted by system 100 in step 225 to ensure that data 110 both comprises at least the minimum set of specific data points and is formatted such that it conforms with the requirements of the ‘agency’ in order to generate a valid/compliant SSN verification request 116. Thus, in one embodiment, system 100 further comprises SSN Request Review Module 115, for reviewing, pre-processing, and formatting data 110 received from client 105 to generate an ‘agency’ compliant SSN Request 116, at step 225.

In one embodiment, SSN Request Review Module 115 is a document management sub-system for receiving data 110 in electronic form, processing data 110 to ensure ‘agency’ compliance, and generating SSN Request 116. Optionally, as described in detail below, Module 115 also ensures, as part of ‘agency’ compliance, that a valid consent form 130 exists for each of the individuals for whom the SSN verification is being sought.

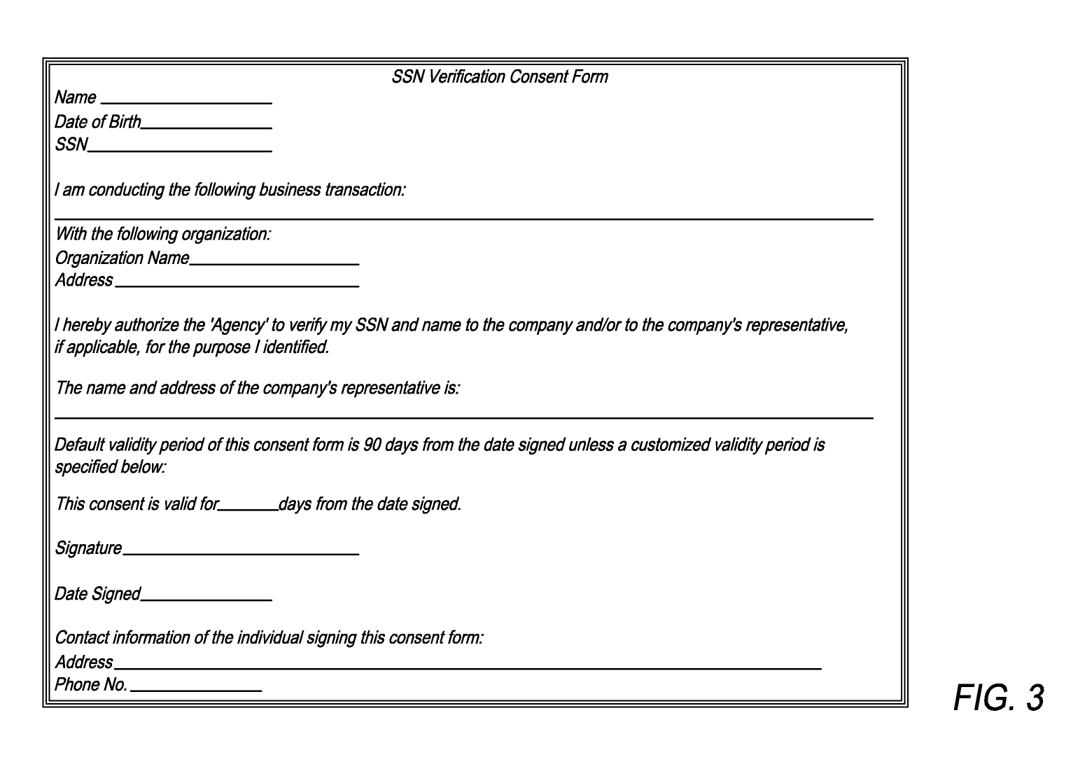

In one embodiment, the ‘agency’s' consent based SSN verification service requires that each individual consent to the verification of their SSN. Thus, consent is generally sought prior to submitting a SSN Verification Request. Persons of ordinary skill in the art would appreciate that the consent of individuals is obtained as signed consent form 130, which, in one embodiment is a standardized consent form such as one shown in FIG. 3. Referring back to FIG. 2, the consent form requires individuals to provide a plurality of data points, such as their name, date of birth, SSN, and the specific business transaction for which the individual is consenting to SSN verification. One of the key features of the form is a default fixed validity period. In one embodiment, the default validity period is 90 days from the date of signing of the consent form. The default validity period can be modified by individuals via indication on the form. Finally, the consent form needs to be signed and dated.

Referring back to FIG. 1, in one embodiment, system 100 further comprises Consent Form Management Module 135 (CFM) that is in data communication with the SSN Request Review Module 115. When SSN Request Review Module 115 reviews data 110 for ‘agency’ compliance, in one optional embodiment, it checks/ensures that a signed and valid consent form 130 exists either within the consent form management module 135 for each individual for whom SSN verification is sought or submitted with data 110.

Consent Form Management Module 135, in one embodiment, stores and manages individual consent forms 130 in accordance with the compliance directives of the ‘agency’. In one embodiment, Consent Form Management Module 135 comprises a database system 136, which may be a relational database management system such as Oracle, MS SQL or any other database known to persons of ordinary skill in the art, for storing consent form 130 in electronic form along with corresponding relational information. In one embodiment, the database system 136 not only stores signed electronic consent form 130 but also maintains a corresponding query-able schema comprising relational information such as name, date of birth, SSN, date of signing of the consent form, the validity period/timeframe and the specific business transaction for which the consent is provided.

In another embodiment, the electronic consent form 130 is stored on a removable electronic media (such as CDs) storage and retrieval system (such as CD player) 137 while the corresponding relational schema is maintained on database 136 for querying.

In a yet another embodiment, the consent form 130 is stored on paper and preferably, in a lockable, fireproof storage receptacle (not shown) such as a cabinet while the relational schema, for each corresponding paper consent form, is maintained on database 136 for querying.

While pre-processing data 110, in one embodiment, SSN Request Review Module 115 queries the Consent Form Management Module 135, in optional step 226, to check if a valid consent form 130 is present corresponding to each of the SSNs (forming part of data 110) and related to the specific business transactions for which the verification is being sought. On receipt of the query, the relational schema of database 136 is checked to see if a corresponding valid consent form 130 exists for each of the SSNs. If yes, then the Request Review Module 115 proceeds with generating the ‘agency’ compliant SSN Request 116 in step 225. If a valid consent form 130 does not exist for any of the SSNs, the Module 115 stops further processing for those SSNs and generates an output, in step 227, to prompt the client 105 to submit valid consent forms for such SSNs. Optionally, client 105 may, in step 228, submit a valid consent form 130 for processing and subsequent storage into Consent Form Management Module 135. Optionally, Module 115 may present client 105 with at least one option for submitting a valid consent form 130.

Thus, in cases where a valid consent form 130 does not pre-exist with the consent form management module 135, the present embodiment contemplates a plurality of consent management cases. In a first embodiment, an on-line consent form may be presented to the client 105 to provide to the individual (not shown). In one embodiment, the on-line consent form is similar to standard form shown in FIG. 2. The form 130 is digitally signed, on-line, by the individual and submitted to the system 100 via the GUI 106 on client 105. In one embodiment, the online consent form 130 is valid for any or all business transactions. In another embodiment the on-line consent form 130 is specific to a business transaction and therefore needs to be obtained each time an individual enters into a business transaction for which a valid consent form does not pre-exist.

In a second embodiment, an on-line consent form 130 may be provided that gives unlimited “forever good” consent to access SSN records. Thus, the individual would only need to sign one consent form that is maintained in a repository. The ‘forever good’ consent form varies from the form of FIG. 2 in terms that the validity period of the form is infinite or of a very long duration such as ‘x’ years and can be renewed/resigned at the expiry of the validity period or that needs to be renewed/resigned at periodic intervals such as annually or bi-annually or at any other suitable interval of time. The ‘forever good’ consent form 130 is also valid for any and all business transactions that the individual, whose SSN needs to be verified, intends to enter into. It should further be appreciated that any length of time can be assigned to define the valid state of the consent form, e.g. 1 day, 1 month, 90 days, 1 year, 10 years, and the like.

In a third embodiment, a consent form 130, already signed or an electronic copy of a physically signed consent form, may be uploaded for storage in Consent Form Management Module 135. Thus, an individual may be presented with an electronic consent form, say via email or website for signature. Once signed, either digitally or physically, the consent form is submitted to the system 100 by uploading through web GUI 106. Optionally, the valid consent form 130 may be uploaded in real time at step 227, when client 105 is prompted to submit a valid consent form 130.

In a fourth embodiment, an individual has a valid consent form 130 (standard, ‘forever good’ form in electronic and/or physical format) signed and maintained with the Consent Form Management Module 135 of system 100. In such a case, the individual is given a special SSN check ID number (may also be alphanumeric) in recognition of the fact that the individual has a valid consent form 130 in place with system 100. This special SSN check ID is allowed to be submitted by the individual for business transactions that require SSN verification. The institution that receives the SSN check ID is then allowed to access the system 100 via a special XML protocol to get the consent form corresponding to the special ID. The special SSN check ID can be submitted to system 100 either online, by phone or in person.

The signatures of individuals on consent form 130 of the present invention comprise physical/handwritten signatures, electronic signatures as well as digital signatures. In one embodiment signatures of individuals are obtained via computer-pen based interface. In one embodiment, a mobile wireless signature capture device is in communication with Consent Form Management Module 135. In one embodiment the communication is through a Virtual Private Network. However, in alternate embodiments the communication is thorough the Internet. A computing-pen is used with the signature capture device to capture the individual's signature. Persons of ordinary skill in the art should appreciate that the mobile wireless signature capture device can be conveniently deployed at the point of service (such as while applying for a license, at a security checkpoint, at a retailer checkout, at a doctor's clinic/hospital, as described in further detail below) to get a real-time signature from an individual that is then used for the consent form 130.

These consent forms 130 that are digitally signed online or offline (or are electronic copies of physically signed consent forms) are sent, by Request Review Module 115, to the consent form management module 135, comprising relational database 136 and/or a combination of retrievable electronic media storage and retrieval system 137 (such as CD/CD player), for archiving and generation of relational query-able schema as described above.

In another embodiment, consent form 130 is submitted by client 105 as part of data 110. Thus, Request Review Module 115 detects consent form 130 while pre-processing data 110. The Request Review Module 115 checks the validity of the form 130 and also queries the consent form management module 135 to check if any previously submitted and stored form exists for the SSN and the business transaction corresponding to the individual who has now submitted the form 130. If no valid consent form exists within module 135, then the newly submitted form 130 is accepted and appropriately archived (as described earlier) by module 135 and the corresponding relational schema updated in database 136.

However, if another valid consent form exists with the Consent Form Management Module 135, it is further checked to see whether the validity period of the earlier stored form or that of the recently submitted new form 130 is larger with reference to the date of signing of the new consent form 130. If the validity period of the earlier stored form is longer than that of the newly submitted form 130, then the earlier stored form is retained and the newly submitted form 130 is sent back to the client 105 with a reason that a valid form already exists for the business transaction and that the validity period of the already existing form is longer than that of the newly submitted form 130.

However, if the validity period of the newly submitted form 130 is longer than that of the earlier existing form, then the newly submitted form 130 is accepted and appropriately archived (as described earlier) by module 135 and the corresponding relational schema updated in database 136.

Referring back to both FIGS. 1 and 2 simultaneously, Request Review Module 115 generates the ‘agency’ compliant SSN Request 116, in real-time.

The format of the compliant SSN Request 116 is, in one embodiment, dependent upon the mode of transmission of SSN Request 116 to ‘agency’ 120. In one embodiment, the SSN request 116 is submitted to the ‘agency’ as an electronic file in batch mode format for response in a specified period of time. For example, for submitting the SSN Request 116 as an electronic file in batch mode format the input electronic file, in one embodiment, must conform to the specification and input record format described and published by the ‘agency’.

In another embodiment, the SSN request 116 is submitted to the ‘agency’ as a single request for real-time response by connecting to the ‘agency’ 120 through the Internet. In this embodiment, in order to complete the SSN verification request 116, the client 105 inputs at least the 9-digit SSN and the first and last names as required data 110 of each individual whose SSN is sought to be verified. Optionally, the client 105 may input additional information such as middle name, suffix, date of birth and gender. However, as noted above, the data 110 that the client 105 inputs need to conform to the specifications that may be specifically described and published by the ‘agency’.

In one embodiment, SSN Request 116 is encrypted at step 230 by encryption module 117 to produce encrypted SSN Request 118. Thus, in one embodiment, system 100 further comprises Encryption Module 117. Thus, in one embodiment, the ‘agency’ compliant SSN Request 116 is encrypted, using Module 117, prior to submission to ‘agency’ 120. System 100 uses the Advanced Encryption Standard (AES), or triple DES (DES3) or any other encryption method as required by the ‘agency’. Encrypted SSN Request 118 is then submitted to the ‘agency’ by connecting to a web application in data communication with ‘agency’ 120. In one embodiment, data communication is achieved by connecting to the internet, wired or wirelessly, using TLS (Transport Layer Security) protocol, such as, but not limited to TLS 1.0.

In one embodiment, at step 235, SSN Request 118, is submitted to ‘agency’ 120 for verification. Upon receipt of the encrypted SSN Request 118 the ‘agency’ 120, at step 240, processes the request and sends back, at step 245, a SSN Verification Output 119, which is encrypted using the same method that was used to generate Encrypted SSN Request 118. System 100 receives encrypted SSN Verification Output 119, decrypts it at step 250, reformats for client 105 so that it is client-ready and sends SSN Verification Information 125 to client 105 at step 255.

In one embodiment, SSN Verification Information 125 comprises a ‘yes’ or ‘no’ verification statement/text/pdf of whether the SSN Request 116 provided could be verified and correlated with the agency's records. In another embodiment the SSN verification information 125 is immediately accessible or accessible in real-time (through step 215) as soon as the client 105 successfully submits the necessary data 110 and consent form 130 necessary to generate the ‘agency’ compliant SSN request 116. Alternatively or additionally the information 125 is emailed or faxed to the client 105 at the address that was specified by the client for communication at the time of registering with the system 100 and/or a call is made to the client 105 to communicate the verification results.

Thus, the verification system 100 of the present invention provides online submission of necessary data 110 as well electronic signing of the requisite consent form 130 (in cases where such a form does not pre-exist with system 100), online, to provide the client with SSN verification in real-time or almost instantaneously. System 100 also contemplates a plurality of novel consent form management cases (described earlier), enabling quick, real-time and instantaneous SSN checks.

The SSN verification system 100 of the present invention is advantageously applicable to a plurality of transactions where SSN identification and verification may be necessary. Such examples are provided below and should not be construed as limiting, but rather exemplary in describing the many applications of the system of the present invention. Reference will be made to the system of FIG. 1 where appropriate. In one embodiment, the SSN verification system of the present invention may be employed with any transaction in which the individual fills out an informational form. In one embodiment, the form is contained on-line and can be accessed using the Internet via a web app on a GUI.

It should be appreciated that the functions and features described in the operational steps above are implemented by software code executing on a processor in a computing device. The computing device can be any personal computer, laptop, server, hand-held device, mobile phone, or other computing device with an integrated display or in communication with a display.

### Credit Report Scrub

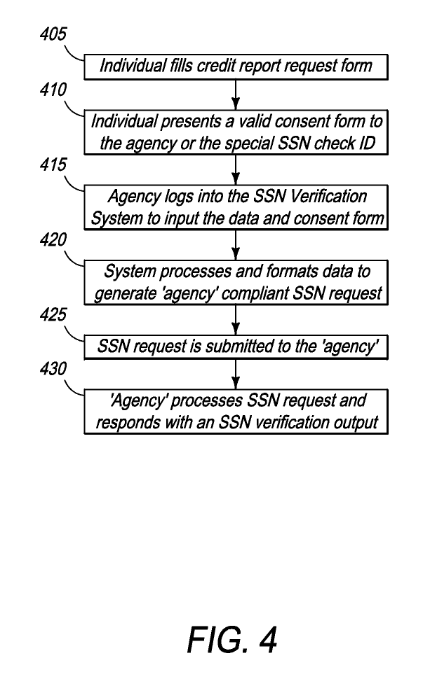

FIG. 4 is a flowchart describing operational steps of one exemplary application of the system and method of the present invention, where an individual wishes to initiate a “credit report scrub” from a credit reporting organization. Referring now to FIGS. 1 and 4 simultaneously, at step 405, to obtain the report, an individual accesses the credit reporting organization's online credit report scrub service/website, through the Internet, and fills out an online credit report request form to a credit reporting organization that includes necessary data fields to enable extraction of data 110—as mandated by ‘agency’ 120. In another embodiment, the request form is filled out physically in the form of paper documents and/or in electronic form and submitted, say, as a pdf document to the credit reporting agency via email or faxed. Data 110 may then be derived from the credit report request form for input into SSN verification system 100.

At step 410, the credit reporting organization 105 asks the individual to also present a valid consent form 130 to allow the organization to verify the individual's SSN. In one embodiment, the consent form 130 (such as standard form of FIG. 3, “forever good” consent form or any other form as described earlier) is manually filled out by the individual and submitted to the organization. In another embodiment, organization 105 presents an electronic consent form 130 to the individual, as part of the online credit report requesting process, who then fills out and digitally signs the form. Still alternatively, the individual shares his special SSN check ID with the organization either on an online credit report request form or on a physical/electronic request form.

At step 415, the organization 105 then logs into the SSN check system 100 of FIG. 1, submits data 110 pertaining to a request to verify/check the authenticity of the individual's SSN and uploads the consent form 130 that was digitally signed by the individual or submits the physical or electronic copy of a physically signed consent form 130. Persons of ordinary skill in the art should note that the organization need not log-in manually to access the SSN verification service. This can be automatically and seamlessly accomplished wherein data 110 and the digitally signed consent form is automatically logged into the SSN check system 100 as soon as the individual completes the online request for credit reports and in the process digitally signs the consent form. Once submitted, system 100 processes and formats data 110 to generate an ‘agency’ compliant SSN request, at step 420. The SSN request is submitted to the ‘agency’ at step 425. On receipt, the ‘agency’ processes SSN request and responds, at step 430, with an SSN verification output for use by the agency. Thereafter, the credit reporting organization prepares the report and highlights all such areas in the credit report that do not match the SSN verification output report received from the ‘agency’. It then sends an alarm to the individual via email, fax, or a call.

### Financial Application (Includes but is not Limited to Credit Card, Mortgage, Loan, etc.)

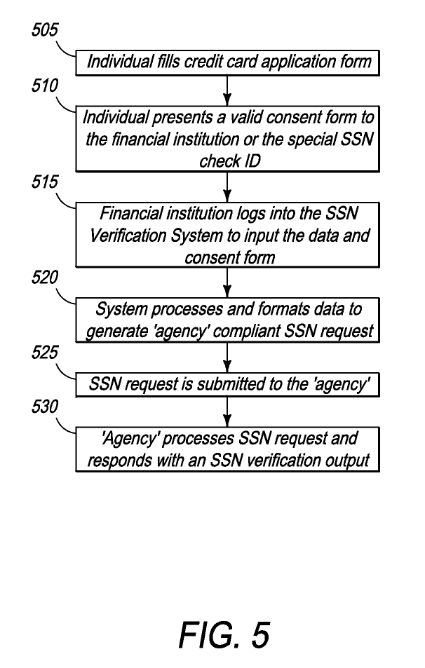

FIG. 5 is a flowchart describing operational steps of another exemplary application of the system and method of the present invention, where an individual is in the process of applying for a credit card or other credit from a financial institution. Referring now to FIGS. 1 and 5 simultaneously, at step 505, the individual fills out a credit card application form that includes necessary data fields to enable extraction of data 110, as describe above and mandated by ‘agency’ 120. The application form is filled out physically in the form of paper documents and/or in electronic form and submitted to the institution via email, fax, or other electronic transmission. Still further the application form may be a web-enabled online e-form that the individual can access and fill out on the website of the institution 105.

Data 110 may then be derived from the credit card application form for input into SSN verification system 100. At step 510, the financial institution 105 asks the applicant to present a valid consent form 130 to allow the institution to verify the applicant's SSN. In one embodiment, the consent form 130 (such as standard form of FIG. 3, “forever good” consent form or any other form as described earlier) is manually filled out by the applicant and submitted to the financial institution concurrently with the credit card application. In another embodiment, institution 105 presents an electronic consent form 130 to the applicant, as part of the online application process, who then fills it out and digitally signs the form. In one embodiment the credit card application form also comprises a consent form section both in case of the physical as well as the web-enabled online e-form. Thus an integrated credit application and consent form is presented to the individual. Still alternatively, the applicant shares his special SSN check ID with the financial institution either on an online credit card application form or on a physical/electronic application form.

At step 515 the financial institution then logs into the SSN check system 100 of FIG. 1, submits data 110 pertaining to a request to verify/check the authenticity of the individual's SSN and uploads the consent form that was digitally signed by the applicant or submits the physical or electronic copy of a physically signed consent form. Persons of ordinary skill in the art would note that the financial institution need not log-in manually to access the SSN verification service. This can be automatically and seamlessly accomplished wherein data 110 and the digitally signed consent form is automatically logged into the SSN check system 100 as soon as the applicant completes the online application for credit cards and in the process digitally signs the consent form. This also holds true in case of the embodiment where the consent form is integrated within the credit application form. In the integrated embodiment the consent form is parsed out of the integrated application form and submitted to the ‘agency’ along with data 110. Once submitted, system 100 processes and formats data 110 to generate an ‘agency’ compliant SSN request, at step 520. The SSN request is submitted to the ‘agency’ at step 525. On receipt, the ‘agency’ processes SSN request and responds, at step 530, with an SSN verification output for use by the financial institution. Thereafter, the SSN verification output obtained in step 530 along with the credit score, as a result of conventional assessment of the individual's creditworthiness, are presented to the individual with a credit card consent or denial.

### Property Lease/Rental.

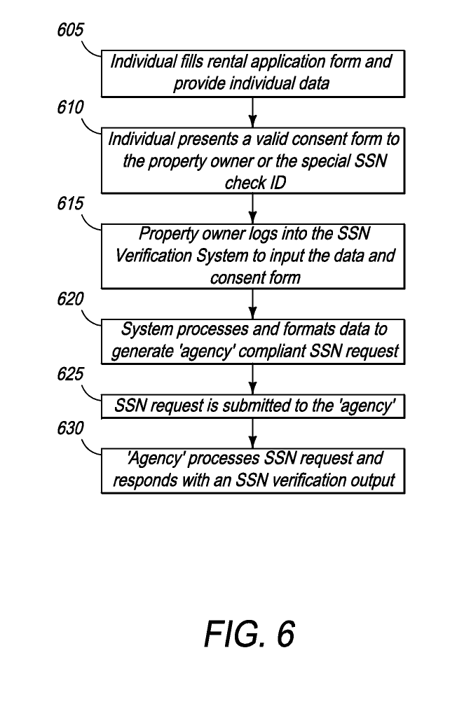

FIG. 6 is a flowchart describing operational steps of yet another exemplary application, where an individual applies for property rental or lease, such as an office space or residential apartment. Referring now to FIGS. 1 and 6 simultaneously, as part of the rental process, the property owner generally would like to ascertain if the individual who is renting the property is a reliable tenant and the actual intended lessee. Therefore, as part of the rental process, in step 605 the property owner asks necessary information from the renter to generate data 110 pertaining to a SSN verification request. Data 110 is obtained from the renter either by having the renter fill out a physical rental document/application form, which is submitted to a property owner as physical document or as an electronic copy, or by having the renter fill out an online rental application form. An example of one such rental application form for residential dwellings is available at http://www.uslandlordforms.com/sampleform.pdf which is hereby incorporated by reference. Persons of ordinary skill in the art would appreciate that the rental application form(s) can be customized to ensure that renter's information is captured as needed to derive data 110.

The property owner asks, at step 610, the renter to present a valid consent form 130 to allow the owner to verify the renter's SSN. In one embodiment, the consent form 130 (such as standard form of FIG. 3, “forever good” consent form or any other form as described earlier) is manually filled out, signed by the renter and submitted to the property owner as physical document or as an electronic copy. In another embodiment, property owner 105 presents an electronic consent form 130 to the renter, as part of the online rental application process, who then fills it out and digitally signs the form. Still alternatively, the renter shares his special SSN check ID with the property owner either on the online rental application form or on a physical/electronic rental application form.

At step 615 the property owner then logs into the SSN check system 100 of FIG. 1, submits data 110 pertaining to a request to verify/check the authenticity of the renter's SSN and uploads the consent form that was digitally signed by the applicant or submits the physical or electronic copy of a physically signed consent form. Persons of ordinary skill in the art would note that the property owner need not log-in manually to access the SSN verification service. This can be automatically and seamlessly accomplished wherein data 110 and the digitally signed consent form is automatically logged into the SSN check system 100 as soon as the renter completes the online rental application form and in the process digitally signs the consent form. Once submitted, system 100 processes and formats data 110 to generate an ‘agency’ compliant SSN request, at step 620. The SSN request is submitted to the ‘agency’ at step 625. On receipt, the ‘agency’ processes SSN request and responds, at step 630, with an SSN verification output for use by the property owner.

### Utility Service (Includes but is not Limited to Phone, Cell Phone, Water, Electricity, etc.).

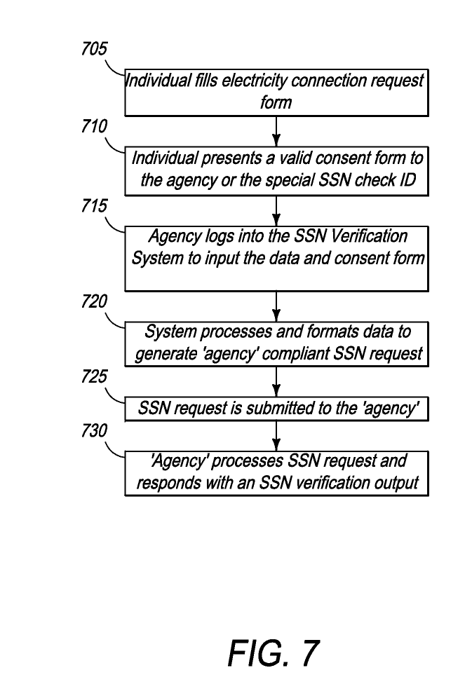

FIG. 7 is a flowchart describing operational steps of another exemplary application, where an individual seeks electricity connection from an electricity distribution organization. Referring now to FIGS. 1 and 7 simultaneously, at step 705, the individual fills out an electricity connection request form that includes necessary data fields to enable extraction of data 110—as mandated by ‘agency’ 120. The request form is filled out physically in the form of paper documents and/or in electronic form and electronically submitted. Still further the request form may be a web-enabled online e-form that the individual can access and fill out on the website of the organization 105. Data 110 may then be derived from the electricity connection request form for input into SSN verification system 100. At step 710, the organization 105 asks the individual to also present a valid consent form 130 to allow the organization to verify the applicant's SSN.

In one embodiment, the consent form 130 (such as standard form of FIG. 3, “forever good” consent form or any other form as described earlier) is manually filled out by the individual and submitted to the organization. In another embodiment, organization 105 presents an electronic consent form 130 to the individual, as part of the online connection request process, who then fills it out and digitally signs the form. Still alternatively, the individual shares his special SSN check ID with the organization either on an online electricity connection request form or on a physical/electronic form.

At step 715 the organization then logs into the SSN check system 100 of FIG. 1, submits data 110 pertaining to a request to verify/check the authenticity of the individual's SSN and uploads the consent form that was digitally signed by the individual or submits the physical or electronic copy of a physically signed consent form. Persons of ordinary skill in the art would note that the utility organization need not log-in manually to access the SSN verification service. This can be automatically and seamlessly accomplished wherein data 110 and the digitally signed consent form is automatically logged into the SSN check system 100 as soon as the individual completes the online request for electricity connection and in the process digitally signs the consent form. Once submitted, system 100 processes and formats data 110 to generate an ‘agency’ compliant SSN request, at step 720. The SSN request is submitted to the ‘agency’ at step 725. On receipt, the ‘agency’ processes SSN request and responds, at step 730, with an SSN verification output for use by the agency.

### On-Line Transaction.

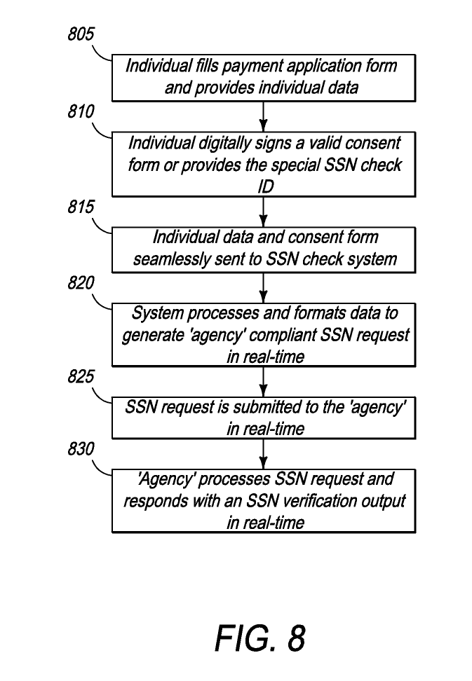

FIG. 8 is a flowchart describing operational steps of an exemplary application, where an individual enters into an online transaction (e-commerce) or purchase. Referring now to FIGS. 1 and 8 simultaneously, as part of the online payment process, the individual is asked, at step 805, to provide data 110 pertaining to a request for verification of his SSN on an online payment application form. At step 810, the individual is also presented with an online consent form that is filled-out and digitally signed by the individual. On submission, the digitally signed consent form and data 110 is seamlessly sent to SSN check system 100 at step 815. Alternatively, the individual can share his special SSN check ID instead of filling and digitally signing a consent form. Once submitted, system 100 processes and formats data 110 to generate an ‘agency’ compliant SSN request in real-time, at step 820. The SSN request is submitted to the ‘agency’ at step 825. On receipt, the ‘agency’ processes SSN request and in real-time responds, at step 830, with an SSN verification output.

### Judgments, Liens, Court Orders (Includes Garnishment of Wages).

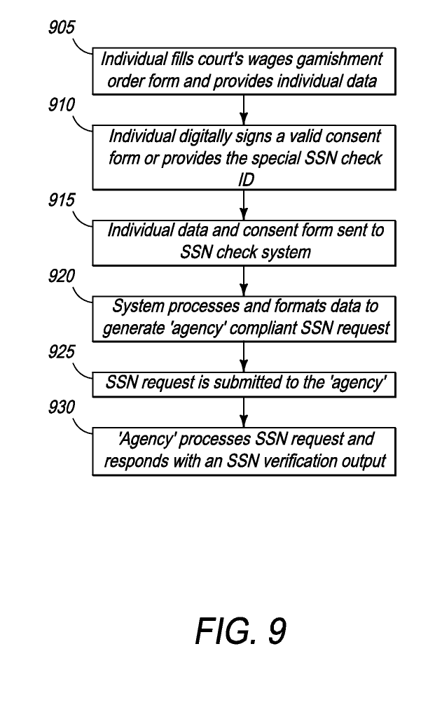

FIG. 9 is a flowchart describing operational steps of another exemplary application, where SSN check is performed before satisfying a judgment, lien or court order, such as a garnishment of wages, to ensure that the garnishment is being applied to the right individual's account. Referring now to FIGS. 1 and 9 simultaneously, as part of the garnishment process, at step 905 the court asks necessary information from the individual to generate data 110 pertaining to a SSN verification request. Data 110 is obtained from the individual either by having the individual fill out a physical wages garnishment document/order form, which is submitted to the court as physical document or as an electronic copy, or by having the individual fill out an online wages garnishment order form. Persons of ordinary skill in the art would appreciate that the court also asks the individual, at step 910, to present a valid consent form 130 to allow the court to verify the individual's SSN.

In one embodiment, the consent form 130 (such as standard form of FIG. 3, “forever good” consent form or any other form as described earlier) is manually filled out, signed by the individual and submitted to the court as physical document or as an electronic copy. In another embodiment, court 105 presents an electronic consent form 130 to the individual, as part of the online wages garnishment order process, who then fills it out and digitally signs the form. Still alternatively, the individual shares his special SSN check ID with the court either on the online wages garnishment order form or on a physical/electronic order form.

At step 915 the court then logs into the SSN check system 100 of FIG. 1, submits data 110 pertaining to a request to verify/check the authenticity of the individual's SSN and uploads the consent form that was digitally signed by the individual or submits the physical or electronic copy of a physically signed consent form. Persons of ordinary skill in the art would note that the court need not log-in manually to access the SSN verification service. This can be automatically and seamlessly accomplished wherein data 110 and the digitally signed consent form is automatically logged into the SSN check system 100 as soon as the individual completes the online wages garnishment order form and in the process digitally signs the consent form. Once submitted, system 100 processes and formats data 110 to generate an ‘agency’ compliant SSN request, at step 920. The SSN request is submitted to the ‘agency’ at step 925. On receipt, the ‘agency’ processes SSN request and responds, at step 930, with an SSN verification output for use by the court.

### Human Resources.

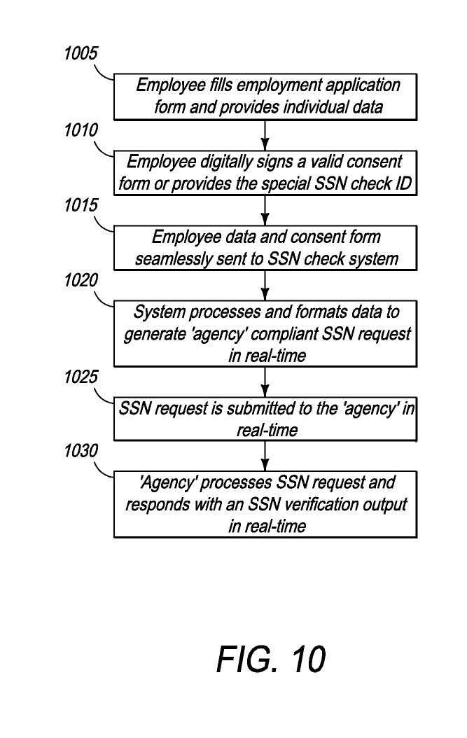

FIG. 10 is a flowchart describing operational steps of another exemplary application, where a human resources department requests a real-time SSN check of at least one employee either prior to or during employment. Referring now to FIGS. 1 and 10 simultaneously, as part of the employee verification process, the employee is asked, at step 1005, to provide data 110 pertaining to a request for verification of his SSN on an online employment application form. At step 1010, the individual is also presented with an online consent form that is filled-out and digitally signed by the employee. In alternate embodiments, the employment application form and the consent form is filled out and submitted as physical documents or as electronic copies. On submission, the digitally signed consent form and data 110 is seamlessly sent to SSN check system 100 at step 1015. Alternatively, the employee can share his special SSN check ID instead of filling and digitally signing a consent form. Once submitted, system 100 processes and formats data 110 to generate an ‘agency’ compliant SSN request in real-time, at step 1020. The SSN request is submitted to the ‘agency’ at step 1025. On receipt, the ‘agency’ processes SSN request and in real-time responds, at step 1030, with an SSN verification output.

### Professional Services.

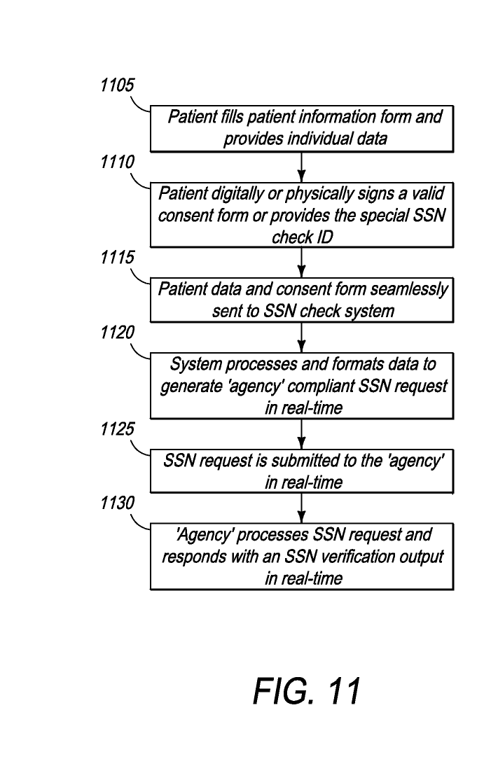

FIG. 11 is a flowchart describing operational steps of an exemplary application, where a physician, or other professional, initiates a real-time SSN verification prior to accepting a new patient or client. Referring now to FIGS. 1 and 11 simultaneously, in the example of a physician, as part of the patient verification process, the patient is asked, at step 1105, to provide data 110 pertaining to a request for verification of his SSN on an online patient information form. At step 1110, the patient is also presented with an online consent form that is filled-out and digitally signed by the patient. In alternate embodiments, the patient information form and the consent form is filled out and submitted as physical documents or as electronic copies. In this case data 110 is derived from the physical documents and input by the doctor in the SSN check system 100 along with uploading of an electronic copy of the consent form thereto. In case of online submission, the digitally signed consent form and data 110 is seamlessly sent to SSN check system 100 at step 1115. Alternatively, the patient can share his special SSN check ID instead of filling and digitally signing a consent form. Once submitted, system 100 processes and formats data 110 to generate an ‘agency’ compliant SSN request in real-time, at step 1120. The SSN request is submitted to the ‘agency’ at step 1125. On receipt, the ‘agency’ processes SSN request and in real-time responds, at step 1130, with an SSN verification output.

### Insurance.

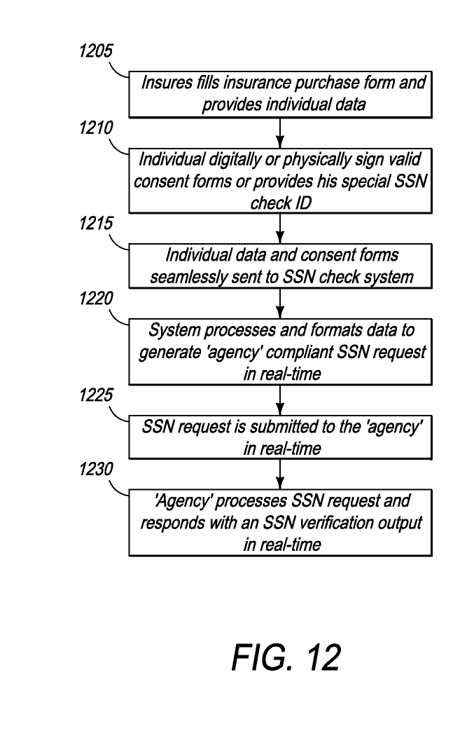

FIG. 12 is a flowchart describing operational steps of another exemplary application, where insurance companies, offer lower premiums to individuals in exchange for an imposed requirement for real-time SSN verifications on their credit report, which can enhance security and helps prevent fraud. Referring now to FIGS. 1 and 12 simultaneously, as part of the insurance application process, an individual who wishes to be insured is asked, at step 1205, to provide data 110 pertaining to a request for verification of his SSN on an insurance purchase form (either a web-based form or a physical or downloadable application). At step 1210, the individual is also presented with an online consent form that is filled-out and digitally signed. In an alternate embodiment, the insurance purchase form and the consent forms are filled out and submitted as physical documents or as electronic copies. In this case data 110 is derived from the physical documents and input by the insurance company 105 into the SSN check system 100 along with uploading of electronic copies of the consent forms thereto. In case of online submission, the digitally signed consent form and data 110 is seamlessly sent to SSN check system 100 at step 1215. Alternatively, the individual can share his special SSN check ID instead of filling and digitally signing consent forms. Once submitted, system 100 processes and formats data 110 to generate an ‘agency’ compliant SSN request in real-time, at step 1220. The SSN request is submitted to the ‘agency’ at step 1225. On receipt, the ‘agency’ processes SSN request and in real-time responds, at step 1230, with an SSN verification output.

### Licenses, Such as Driver's or Marriage License.

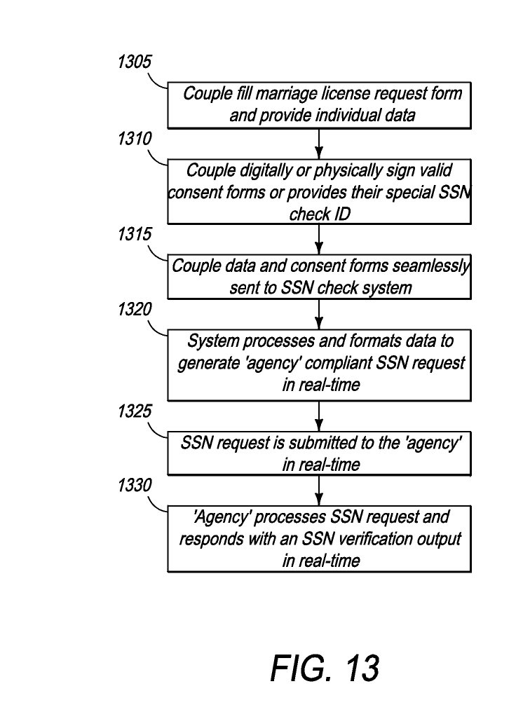

FIG. 13 is a flowchart describing operational steps of yet another exemplary application, where a city clerk or government official conducts a real-time SSN check before issuing a license. Referring now to FIGS. 1 and 13 simultaneously, as part of the couple verification process for a marriage license for example, the couple is asked, at step 1305, to provide data 110 pertaining to a request for verification of their SSN on an online marriage license request form. At step 1310, the couple is also presented with online consent forms that are filled-out and digitally signed by the couple. In alternate embodiments, the marriage license request form and the consent forms are filled out and submitted as physical documents or as electronic copies. In this case data 110 is derived from the physical documents and input by the government bureau into the SSN check system 100 along with uploading of electronic copies of the consent forms thereto. In case of online submission, the digitally signed consent form and data 110 is seamlessly sent to SSN check system 100 at step 1315. Alternatively, the couple can share their special SSN check ID instead of filling and digitally signing consent forms. Once submitted, system 100 processes and formats data 110 to generate an ‘agency’ compliant SSN request in real-time, at step 1320. The SSN request is submitted to the ‘agency’ at step 1325. On receipt, the ‘agency’ processes SSN request and in real-time responds, at step 1330, with an SSN verification output.

### Ticketed Transportation.

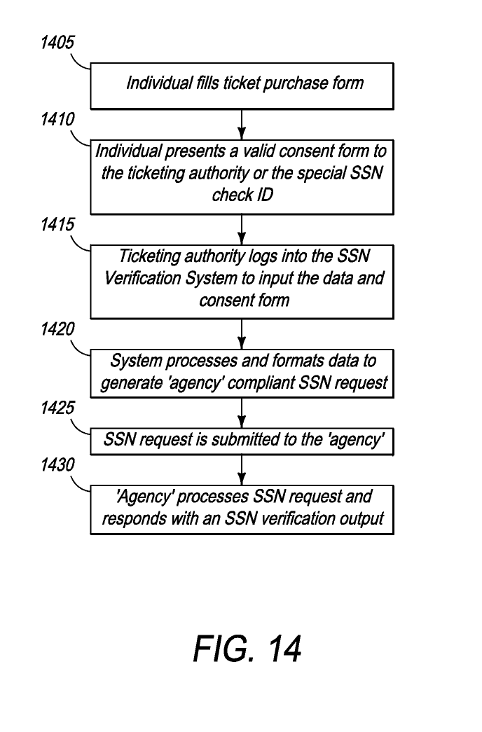

FIG. 14 is a flowchart describing operational steps of another exemplary application, where an individual consents to SSN verification upon purchase of a ticket for public transportation. SSN verification may provide the individual with a special security status or a fasttrack security check on public transport, such as an airplane. Referring now to FIGS. 1 and 14 simultaneously, as part of the ticket purchase process, at step 1405 the ticketing authority asks necessary information from the individual to generate data 110 pertaining to a SSN verification request. Data 110 is obtained from the individual either by having the individual fill out a physical ticket purchase document/form, which is submitted to the ticketing authority as physical document or as an electronic copy, or by having the individual fill out an online ticket purchase form. Persons of ordinary skill in the art would appreciate that the ticket purchase form can be customized to ensure that individual's information is captured as needed to derive data 110. The ticketing authority also asks, at step 1410, the individual to present a valid consent form 130 to allow the ticketing authority to verify the individual's SSN. In one embodiment, the consent form 130 (such as standard form of FIG. 3, “forever good” consent form or any other form as described earlier) is manually filled out, signed by the individual and submitted to the ticketing authority as physical document or as an electronic copy. In another embodiment, ticketing authority 105 presents an electronic consent form 130 to the individual, as part of the online ticket purchase process, who then fills it out and digitally signs the form. Still alternatively, the individual shares his special SSN check ID with the ticketing authority either on the online ticket purchase form or on a physical/electronic form. At step 1415 the ticketing authority then logs into the SSN check system 100 of FIG. 1, submits data 110 pertaining to a request to verify/check the authenticity of the individual's SSN and uploads the consent form that was digitally signed by the individual or submits the physical or electronic copy of a physically signed consent form. Persons of ordinary skill in the art would note that the ticketing authority need not log-in manually to access the SSN verification service. This can be automatically and seamlessly accomplished wherein data 110 and the digitally signed consent form is automatically logged into the SSN check system 100 as soon as the individual completes the online ticket purchase form and in the process digitally signs the consent form. Once submitted, system 100 processes and formats data 110 to generate an ‘agency’ compliant SSN request, at step 1420. The SSN request is submitted to the ‘agency’ at step 1425. On receipt, the ‘agency’ processes SSN request and responds, at step 1430, with an SSN verification output for use by the ticketing authority.

### Bankruptcy Declaration

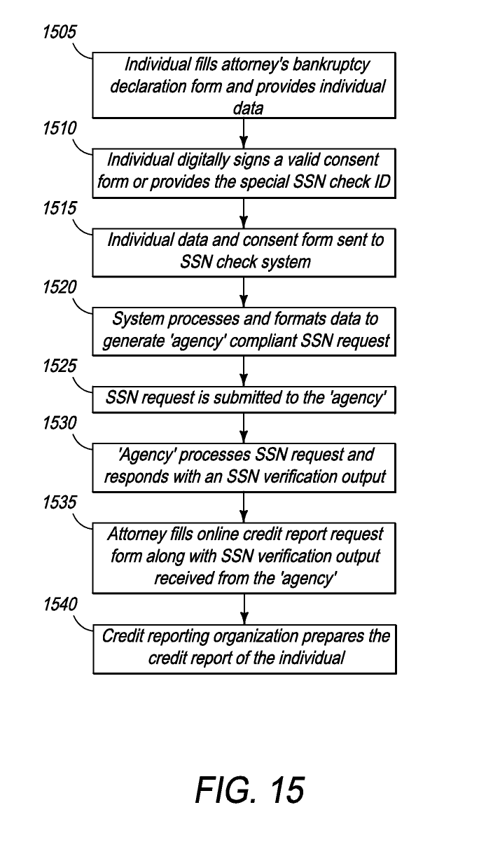

FIG. 15 is a flowchart describing operational steps of another exemplary application, where an attorney performs SSN check of an individual who wants to declare bankruptcy. In one embodiment, the attorney also wants to ascertain that the individual declaring bankruptcy has no income/low income. In one embodiment this is ascertained by initiating a “credit report scrub” from a credit reporting agency for the individual. Referring now to FIGS. 1 and 15 simultaneously, as part of the bankruptcy declaration process, at step 1505 the attorney asks necessary information from the individual to generate data 110 pertaining to a SSN verification request. Data 110 is obtained from the individual either by having the individual fill out a physical bankruptcy declaration document/form, which is submitted to the attorney as physical document or as an electronic copy, or by having the individual fill out an online bankruptcy form. Persons of ordinary skill in the art would appreciate that the attorney also asks the individual, at step 1510, to present a valid consent form 130 to allow the attorney to verify the individual's SSN.

In one embodiment, the consent form 130 (such as standard form of FIG. 3, “forever good” consent form or any other form as described earlier) is manually filled out, signed by the individual and submitted to the attorney as physical document or as an electronic copy. In another embodiment, attorney 105 presents an electronic consent form 130 to the individual, as part of the online bankruptcy declaration process, who then fills it out and digitally signs the form. Still alternatively, the individual shares his special SSN check ID with the attorney either on the online bankruptcy declaration form or on a physical/electronic form. At step 1515 the attorney then logs into the SSN check system 100 of FIG. 1, submits data 110 pertaining to a request to verify/check the authenticity of the individual's SSN and uploads the consent form that was digitally signed by the individual or submits the physical or electronic copy of a physically signed consent form. Persons of ordinary skill in the art would note that the attorney need not log-in manually to access the SSN verification service. This can be automatically and seamlessly accomplished wherein data 110 and the digitally signed consent form is automatically logged into the SSN check system 100 as soon as the individual completes the online bankruptcy declaration form and in the process digitally signs the consent form. Once submitted, system 100 processes and formats data 110 to generate an ‘agency’ compliant SSN request, at step 1520. The SSN request is submitted to the ‘agency’ at step 1525. On receipt, the ‘agency’ processes SSN request and responds, at step 1530, with an SSN verification output for use by the attorney.

To additionally check for the individual's capacity to pay or to ascertain his/her creditworthiness the attorney initiates a “credit report scrub”, on the individual, from a credit reporting organization. At step 1535, the attorney (on behalf of the individual) accesses the credit reporting organization's online credit report scrub service/website, through the Internet, and fills out an online credit report request form to a credit reporting organization. The attorney also submits, along with the credit report request form, the SSN verification output received by the attorney at step 1530. In another embodiment, the credit report request form is filled out physically in the form of paper documents and/or in electronic form and submitted, say, as a pdf document to the credit reporting agency via email or faxed along with the SSN verification output. Thereafter, at step 1540, the credit reporting organization prepares the individual's credit report and may optionally highlight all such areas in the credit report that do not match the SSN verification output report that was submitted by the attorney.

### Debt Renegotiation

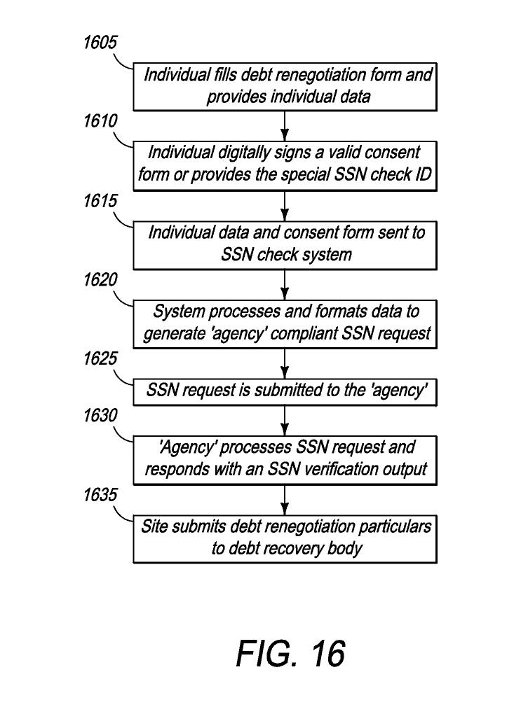

FIG. 16 is a flowchart describing operational steps of another exemplary application, where a site offering debt renegotiation services wants to renegotiate an individual's debt from a relevant debt recovery agency. Referring now to FIGS. 1 and 16 simultaneously, as part of the debt renegotiation process, at step 1605 the debt renegotiation site asks necessary information from the individual to generate data 110 pertaining to a SSN verification request. Data 110 is obtained from the individual either by having the individual fill out a physical debt renegotiation document/form, which is submitted to the renegotiation site as physical document or as an electronic copy, or by having the individual fill out an online debt renegotiation form.

Persons of ordinary skill in the art would appreciate that the debt renegotiation form can be customized to ensure that individual's information is captured as needed to derive data 110. The debt renegotiation site also asks, at step 1610, the individual to present a valid consent form 130 to allow the site to verify the individual's SSN. In one embodiment, the consent form 130 (such as standard form of FIG. 3, “forever good” consent form or any other form as described earlier) is manually filled out, signed by the individual and submitted to the site as physical document or as an electronic copy. In another embodiment, site 105 presents an electronic consent form 130 to the individual, as part of the online debt renegotiation process, who then fills it out and digitally signs the form. Still alternatively, the individual shares his special SSN check ID with the site either on the online debt renegotiation form or on a physical/electronic form. At step 1615 the site then logs into the SSN check system 100 of FIG. 1, submits data 110 pertaining to a request to verify/check the authenticity of the individual's SSN and uploads the consent form that was digitally signed by the individual or submits the physical or electronic copy of a physically signed consent form.

Persons of ordinary skill in the art would note that the site need not log-in manually to access the SSN verification service. This can be automatically and seamlessly accomplished wherein data 110 and the digitally signed consent form is automatically logged into the SSN check system 100 as soon as the individual completes the online debt renegotiation form and in the process digitally signs the consent form. Once submitted, system 100 processes and formats data 110 to generate an ‘agency’ compliant SSN request, at step 1620. The SSN request is submitted to the ‘agency’ at step 1425. On receipt, the ‘agency’ processes SSN request and responds, at step 1630, with an SSN verification output for use by the site. Thereafter, the site, at step 1635, submits the debt renegotiation particulars to the debt recovery/enforcement body.

This application discloses systems and methods of verifying personal identities. It will be understood that various changes in the details, arrangement of elements and operating steps which have been herein described and illustrated in order to explain the nature of the invention may be made by those skilled in the art without departing from the principles and scope of the invention. Therefore, it is intended that this invention not be limited to the particular embodiment disclosed as the best mode contemplated for carrying out the invention, but that the invention will include all embodiments falling within the scope of the appended claims.

We claim:

1. A plurality of programmatic modules stored on computer readable media and, when installed on a computer device, execute on at least one processor comprising:
a. A first programmatic module for receiving login credentials from a first computing device across a network and for verifying said credentials;
b. A second programmatic module for generating, and communicating to said first computing device, a request form for accessing personal identification data associated with a person;
c. A third programmatic module for receiving input data from said first computing device across a network in response to said request form;
d. A fourth programmatic module for testing said input data in relation to a minimum required data set for requesting said personal identification data;
e. A fifth programmatic module for formatting said input data into an electronic request in accordance with a predefined format;
f. A sixth programmatic module for storing, searching, and identifying a consent form, wherein said consent form establishes a valid consent by said person to access said personal identification data;
g. A seventh programmatic module for associating said electronic request for said person's personal identification data with said consent form; and
h. An eighth programmatic module for transmitting said electronic request in accordance with a predefined format to a second computing device.

2. The programmatic modules of claim 1 wherein, if said sixth programmatic module cannot identify said consent form executed by said person, said sixth programmatic module causes a signal to be communicated to said first computing device and wherein said signal causes said first computing device to display a request for said consent form executed by said person.

3. The programmatic modules of claim 1 wherein, if said sixth programmatic module cannot identify said consent form executed by said person, said eighth programmatic module does not submit said electronic request in accordance with a predefined format to a server.

4. The programmatic modules of claim 1 wherein, if said sixth programmatic module can identify said consent form executed by said person, said eighth programmatic module submits said electronic request in accordance with a predefined format to a server.

5. The programmatic modules of claim 1 wherein the personal identification data is a social security number.

6. The programmatic modules of claim 1 wherein said first programmatic module is configured to establish an encrypted connection with said first computing device.

7. The programmatic modules of claim 1 wherein said sixth programmatic module is configured to access a database and wherein said database stores executed consent forms in an electronic format.

8. The programmatic modules of claim 1 wherein said sixth programmatic module is configured to access a database and wherein said database stores metadata of stored consent forms, said metadata comprising data extracted from said stored consent forms and placed into an electronically searchable format.

9. The programmatic modules of claim 1 further comprising a ninth programmatic module for accessing results of at least one previously submitted electronic request.

10. The programmatic modules of claim 1 further comprising a tenth programmatic module for receiving results of at least one electronic request from a third computing device.

11. A system for obtaining social security information of a person with consent from said person comprising:
a. a processor;
b. a memory for storing a plurality of programmatic modules, wherein each of said programmatic modules execute on said processor and wherein said plurality of programmatic modules comprise:
(i) A first programmatic module for receiving login credentials from a first computing device across a network and for verifying said credentials;
(ii) A second programmatic module for generating, and communicating to said first computing device, a request form for accessing said social security information associated with said person;
(iii) A third programmatic module for receiving input data from said first computing device across a network in response to said request form;
(iv) A fourth programmatic module for testing said input data in relation to a minimum required data set for requesting said social security information;
(v) A fifth programmatic module for formatting said input data into an electronic request in accordance with a predefined format;
(vi) A sixth programmatic module for storing, searching, and identifying a consent form, wherein said consent form establishes a valid consent by said person to access said social security information;
(vii) A seventh programmatic module for associating said electronic request for said person's social security information with said consent form; and
(viii) An eighth programmatic module for transmitting said electronic request in accordance with a predefined format to a second computing device; and
c. a database, wherein said database stores executed consent forms in an electronic format and wherein said database is accessible by at least one of said plurality of programmatic modules.

12. The system of claim 11 wherein, if said sixth programmatic module cannot identify said consent form executed by said person, said sixth programmatic module causes a signal to be communicated to said first computing device and wherein said signal causes said first computing device to display a request for said consent form executed by said person.

13. The system of claim 11 wherein, if said sixth programmatic module cannot identify said consent form executed by said person, said eighth programmatic module does not submit said electronic request in accordance with a predefined format to a server.

14. The system of claim 11 wherein, if said sixth programmatic module can identify said consent form executed by said person, said eighth programmatic module submits said electronic request in accordance with a predefined format to a server.

15. The system of claim 11 wherein said first programmatic module is configured to establish an encrypted connection with said first computing device.

16. The system of claim 11 wherein said database stores metadata of stored consent forms, said metadata comprising data extracted from said stored consent forms and placed into an electronically searchable format.

17. The system of claim 11 further comprising a ninth programmatic module for accessing results of at least one previously submitted electronic request.

18. The system of claim 11 further comprising a tenth programmatic module for receiving results of at least one electronic request from a third computing device.

19. The system of claim 18 further comprising an eleventh programmatic module for establishing an encrypted connection with said third computing device.
